(19) United States
(12) Patent Application Publication
(10) Pub. No.: US 2007/0218308 A1
(43) Pub. Date: Sep. 20, 2007

(54) Surface Treatment of Polymeric Articles

(76) Inventors: Kenneth Lewtas, Tervuren (BE); Linda M.G.R. Van Den Bossche, Zwijndrecht (BE); Anne Vera Macedo, Brussels (BE); Jurgen Schroeyers, Helchteren (BE); Nancy Vanderheyden, Langdorp (BE)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/631,563

(22) PCT Filed: Jun. 30, 2005
(86) PCT No.: PCT/US05/23484

§ 371 Date: Jan. 4, 2007

Related U.S. Application Data
(60) Provisional application No. 60/587,587, filed on Jul. 13, 2004.

(51) Int. Cl. C08L 23/02; B32B 27/32; C08L 23/08; C08J 5/18

(52) U.S. Cl. 428/543; 106/285

(57) ABSTRACT

Polymeric surfaces that contain a resin modifier and are surface treated, preferably by corona, flame, gas plasma treatment techniques, exhibit increased surface tension and retention of surface tension over extended periods of time.

This application claims the benefit of Provisional Application No. 60/587,587, filed Jul. 13, 2004, the disclosure of which is incorporated by reference.

### BACKGROUND

This invention relates to energy-treated polymeric surfaces, particularly surface-treated polyolefin films.

Without appropriate surface treatment, some polymeric surfaces are difficult to further process, particularly if the surfaces will be printed or bonded to another material. To aid in further processing, these surfaces are typically treated in a conventional manner to increase the surface tension thereof. Corona (electric) discharge and flame treatment are the most commonly used.

Commercial treatment prior to such printing, painting, coating, bonding or sealing is widespread in various industries. Polyolefin films are often surface treated to allow printing, coating, metallizing or to aid adhesion. Unfortunately, the surface treatment generally deteriorates with time, limiting the shelf-life of the product before it is converted into, for example, a label. Film producers, converters, and/or end users are conscious of this limit as they seek to obtain consistent and reliable results. Most film producers surface treat their film products during production, but some end users and converters purchase their own equipment to surface treat just prior to printing (coating, metallization, etc.) because they are not willing to accept the risk of deteriorated surface treatment effect. It would therefore be advantageous if the self-life of such polymeric articles could be extended. Such advantageous behavior has, so far, been very difficult to achieve. The compositions and processes described herein provide an acceptable route to achieve a beneficial solution to this problem.

The polymeric surfaces and methods for producing such surfaces disclosed herein benefit from (i) enhanced surface treatment by increasing the overall surface tension, (ii) prolonged surface tension effect without significant deterioration over extended periods of time when compared to conventional films, and (iii) increased surface tension at the same or lower overall treatment energies. Polymeric surfaces with relatively low initial surface tensions benefit most, where conventional treatments tend to also deteriorate relatively quickly.

There have been prior disclosures of polyolefins and polar resin combinations in films, for example, WO 03/025084, WO 03/025036, WO 03/025037, WO 03/025038. These disclosures, however, do not appear to recognize that the use of resin modifier in a film in combination with surface treatment, can yield improved surface tension, both initially and over extended time periods and achieve comparable surface tension at lower treatment energies, while avoiding significant impairment of other processing or property parameters.

U.S. Pat. No. 5,212,001 discusses cling films comprising tackifier additives. U.S. Pat. No. 5,888,615 discusses cling films containing maleated styrene butadiene block copolymers. It is believed that such high molecular weight materials do not offer the same performance advantages of the modified polar resins disclosed herein, which give the advantageous surface treatment properties, increased stiffness, and increased processability without adversely affecting other film properties such as optical and barrier properties.

Other background references include WO 04/033550, JP 59 120635 A (XP002316858), EP 1295 926 A, U.S. Pat. No. 4,719,260, U.S. Pat. No. 5,623,011, and U.S. Pat. No. 5,945,225.

### BRIEF DESCRIPTION OF THE FIGURES

FIG. 1 illustrates a comparison of surface tension for (i) a base film of ethylene vinyl acetate and (ii) a film made with the same polymer and a resin modifier.

FIG. 2 illustrates a comparison of surface tension for (i) a base film containing ethylene vinyl acetate and a conventional hydrocarbon resin and (ii) a film made with ethylene vinyl acetate and a resin modifier.

### SUMMARY

One embodiment is a surface treated article, preferably a film, comprising at least one layer comprising about 20 wt % or less of a resin modifier comprising a tackifier selected from the group consisting of aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and mixtures of two or more thereof, wherein the tackifier has a molecular weight (Mw) of about 10,000 or less and wherein the resin modifier comprises about 20 wt % or less unsaturated acid or anhydride or derivative thereof.

Another embodiment is a process comprising: (a) preparing an article having one or more layers, at least one of the layers comprising a polymer and about 20 wt % or less of a resin modifier based on the weight of the layer, the resin modifier having a molecular weight (Mw) of about 10,000 or less and comprising about 20 wt % or less unsaturated acid or anhydride or derivative thereof; and, (b) surface treating the article, preferably the layer comprising the resin modifier, preferably by corona or flame treatment.

Suitable end uses comprise laminates, films, coextruded and extrusion-coated substrates, packaging films, packaged articles of manufacture, labels, tapes and articles of manufacture comprising the labels and/or tape, such as containers. These products are preferably contain at least one coating layer, a printed layer, an adhesive layer or a metal layer, preferably over at least one of the surface treated layers. The resin modifiers described herein can be used to improve the surface tension of a treated film and to increase the surface tension of a treated film.

### DETAILED DESCRIPTION

The articles described herein generally comprise a resin modifier in at least one layer thereof and are surface treated, preferably by corona or flame treatment. The inclusion of the resin modifier in the article provides benefits of increased initial surface tension in some embodiments and continued increased retention of surface tension over a longer period of time when compared to conventional films not containing the resin modifier. A preferred embodiment is a film or laminate.

The film preferably has at least one layer and may have two or more layers that comprise the resin modifier. Suitable films include mono- or multilayer films comprising one, two, three, four, or five or more layers. Although it is preferred to have the resin modifier in the skin layer(s) of a film, it may be acceptable to put the modifier in other layers, for example, when constructing a laminate.

The layer(s) comprising the resin modifier contains the modifier in an amount about 20 wt % or less, more preferably from about 0.01-20 wt %, more preferably from about 0.01-15 wt %, more preferably from about 0.1-15 wt %, more preferably from about 0.1-10 wt %, more preferably from about 0.5-10 wt %, more preferably from about 0.5-8 wt %, more preferably from about 1-7 wt %, more preferably from about 1-5 wt %, more preferably from about 1.5-5 wt % and more preferably from about 2-5 wt % based on the weight of the layer containing the modifier. Other preferred ranges include the combination of any two upper and/or lower limits specified above.

The layers of such articles, films and/or laminates may comprise any polyolefin and/or thermoplastic, for example homopolymers, copolymers and/or terpolymers of C₂ to C₄₀ olefins, preferably C₂ to C₂₀ olefins, preferably a copolymer of an alpha-olefin and another olefin or α-olefin (ethylene is defined to be an α-olefin for purposes herein). Preferred examples include polyolefins and thermoplastic polymers such as ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and blends of thermoplastic polymers and elastomers, such as for example, thermoplastic elastomers and rubber toughened plastics. Other suitable polymers may include homopolymers and copolymers of esters, amides, ethers, acetates, anhydrides, copolymers of a C₂ to C₂₀ olefin, such as ethylene and/or propylene and/or butene with one or more polar monomers such as acetates, anhydrides, esters, alcohol, ether and or acrylics; preferred examples include polyesters, polyamides, ethylene vinyl acetate copolymers, ethylene vinyl alcohol copolymers, acid copolymers, ionomers, acid terpolymers, and polymers grafted with an unsaturated acid, anhydride or derivative thereof, polycarbonates and polyvinyl chloride.

The homopolymers and copolymers may be metallocene polyethylenes (mPE's) or metallocene polypropylenes (mPP's). The usage of the term polyethylene herein is defined to include metallocene polyethylenes and the usage of the term polypropylene herein is defined to include metallocene polypropylenes. Suitable copolymers may include 1-butene, 1-hexene, and/or 1 octene comonomers. The mPE and or mPP homopolymers or copolymers are typically produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. Several commercial products produced with such catalyst/activator combinations are commercially available from ExxonMobil Chemical Company under the tradenames ACHIEVE, EXCEED and EXACT. In one embodiment, the mPE may be a plastomer having a density from about 0.865-0.915 g/cm³.

Other layers can be paper, wood, cardboard, metal, metal foils (such as aluminum foil and tin foil), metallized surfaces, glass (including silicon oxide (SiOₓ) coatings applied by evaporating silicon oxide onto a film surface), fabric, spunbonded fibers, and non-wovens (particularly polypropylene spun bonded fibers or non-wovens), and substrates coated with inks, dyes, pigments, PVC and the like.

The films may be employed as either mono- or multi-layer films or laminates and may be manufactured by any conventional process, including simple bubble extrusion, biaxial orientation processes (such as tenter frames, trapped bubble, or double bubble processes), simple cast/sheet extrusion-lamination, co-extrusion, lamination, extrusion coating, and co-extrusion coating, blowing and casting, etc. Should a multilayer film be desired, it can be coextruded or obtained from a monolayer blown or cast film that can be combined with the other layers though conventional techniques such as adhesive lamination or extrusion lamination.

The film may be obtained by the flat film or tubular process, which may be followed by uni- or biaxial orientation. One or more of the layers of the film may be oriented in the transverse and/or longitudinal directions to the same or different extents. This orientation may occur before or after the individual layers are brought together. For example, a polyethylene layer can be extrusion coated or laminated onto an oriented polypropylene or oriented polyester layer or the polyethylene and polypropylene can be coextruded together into a film and then oriented. Likewise, oriented polypropylene could be laminated to oriented polyethylene; oriented polyethylene could be coated onto polypropylene, and then optionally the combination could be oriented even further. Typically the films are oriented in the machine direction (MD) at a ratio of up to about 15 and in the transverse direction (TD) at a ratio of up to about 15. Orientation conditions depend on the end use and are normally dictated by the film producers.

Other embodiments include mono- and/or coextruded multilayer mono- or biaxially oriented polypropylene and polyethylene films. Such films may comprise a core layer and at least one skin layer. Such films may include a core layer, one or more skin layers and one or more tie layers positioned between the core and skin layers. Each layer may comprise one or more homopolymers, copolymers and/or terpolymers of C₂ to C₄₀ olefins, preferably C₂ to C₂₀ olefins, preferably a copolymer of an alpha-olefin and another olefin or α-olefin, preferably ethylene and/or propylene homopolymers or copolymers and C₂/C₃/C₄ terpolymers. Suitable materials for the core layer preferably comprise polyamide, polyethylene terephthalate, ethylene vinyl alcohol copolymer, polypropylene or polyethylene.

Any of the layers of the films described herein may comprise a conventional hydrocarbon/petroleum resin described below (with or without modification as described herein). Any one or more of the layers may also include void-initiating particles such as calcium carbonate and polybutylene terephthalate (PBT) or other conventional void-initiating particles in amounts from 5-80 wt % based on the weight of the layer. One or more layers may comprise an opacifying agent or pigment material such as iron oxide, carbon black, TiO₂, talc or combinations thereof. Such materials are useful in making white and/or opaque films. The film may be mono- or biaxially oriented in the machine direction (MD) and/or transverse direction (TD). Preferred orientation ratios are MD about 2-10× and/or TD about 2-12×. Such films may be coated (e.g., adhesive, PVdC, PVOH, EVOH, acrylic) and/or metallized in a conventional manner as described in one or more of WO 02/081206, U.S. Pat. No. 3,753,769, U.S. Pat. No. 4,865,908, U.S. Pat. No. 5,057,177, U.S. Pat. No. 5,230,963, U.S. Pat. No. 6,077,602, and U.S. Pat. No. 6,013,353, all of which are incorporated by reference. Methods for producing such oriented films are well-known in the art.

The films may vary in thickness depending on the intended application, however films of a thickness from about 1-500 μm are usually suitable. Films intended for packaging are usually from about 10-60 μm thick. In many cases, the skin layer, when containing the resin modifier, will have a thickness from about 0.5-60 μm, more preferably from about 0.5-50 μm, more preferably 0.5-30 μm, more preferably from about 1-15 μm, and more preferably about 1-3 μm.

One embodiment is a stretch/cling film comprising a slip layer comprising any suitable polyolefin or combination of polyolefins such as polyethylene, polypropylene, ethylene vinyl acetate copolymer (EVA), copolymers of ethylene and propylene, and polymers obtained from ethylene and/or propylene copolymerized with minor amounts of other olefins, particularly C₄-C₂₀ olefins. Particularly preferred are mPEs and plastomers. In some embodiments, low vinyl acetate content EVAs are preferred with vinyl acetate contents below about 25 wt %, more preferably below about 20 wt %, more preferably below about 15 wt %, more preferably below about 10 wt %, more preferably below about 5 wt %, and preferably from about 2-5 wt % vinyl acetate. Suitable polypropylene is preferably isotactic, i.e., greater than about 90% n-heptane insolubles, having wide ranging melt flow rates of from about 0.1-300 g/10 min.

The resin modifier may be added to the material used for the film layer into which it will be incorporated in any convention manner, e.g., melt blending, dry blending, or on-line blending. In melt blending, the individual components where the polymers are first mixed and then extruded in a compounding extruder to obtain pellets that contain a combination of the materials. In dry blending, the components (preferably in pelletized form) are mixed together and then added directly to the extruder used to manufacture the film. Optionally, slip additives, anti-block additives, antioxidants, UV stabilizers, pigments, fillers and other processing aids may be incorporated in either the melt blends or dry blends.

In one embodiment, the resin modifier is employed by using a masterbatch containing the resin modifier and a suitable carrier polymer, which is then optionally suitably blended with the material forming the layer of which the resin modifier is a part, which in many cases will be the same or compatible with the polyolefin used for the film layer, before extrusion into a film layer. Suitable masterbatches can be produced by conventional methods such as compounding in a twin screw extruder, Banbury mixer, and other conventional methods known in the art. The masterbatch would generally contain resin modifier in an amount between about 10-90 wt %, more preferably about 20-80 wt %, more preferably about 30-70 wt %, more preferably about 40-60 wt % and would contain a suitable carrier polymer in an amount between about 10-90 wt %, more preferably about 20-80 wt %, more preferably about 30-70 wt %, more preferably 40-60 wt %, and optionally up to about 60 wt % additives as described herein. Suitable carrier polymers include C₂-C₂₀ α-olefin polymers, copolymers and terpolymers or any of the other polyolefins referred to earlier.

Film additives such as cling agents, antiblock agents, antioxidants, slip additives, pigments, fillers, processing aids, UV stabilizers, neutralizers, lubricants, surfactants and/or nucleating agents may also be present in one or more than one layer in the films. Preferred additives include silicon dioxide, titanium dioxide, polydimethylsiloxane, talc, dyes, wax, calcium stearate, carbon black, low molecular weight resins and glass beads. In one embodiment, the layer(s) may comprise a crosslinking agent. Preferred crosslinking agents include alcohols, polyols, amines, diamines and/or triamines. Examples of crosslinking agents useful include polyamines such as ethylenediamine, diethylenetriamine, hexamethylenediamine, diethylaminopropylamine, and/or menthanediamine. Typical antioxidants include phenolic antioxidants, such as Irganox® 1010, Irganox® 1076 both available from Ciba-Geigy and 3,5tertiary-butyl4-hydroxy toluene.

One or more layers, preferably the layers comprising the resin modifier, are treated by corona treatment, electron beam irradiation, gamma irradiation, flame treatment, gas plasma treatment or microwave treatment. In a preferred embodiment one or both of the outer layers contain the resin modifier, and either or both outer layers are corona treated. The initial surface tension (dynes/cm) of the film imparted by surface treatment is preferably greater than about 30, more preferably greater than about 40, more preferably greater than about 50, and more preferably greater than about 60 dynes/cm. The films described herein retain at least about 75%, preferably at least about 80%, and preferably at least about 90% of the initial surface tension after about 30 days, about 45 days, or even after about 60 days. The retention of surface tension over extended periods of time give the films longer shelf life, which allows the films to be stored longer and in some instances, eliminates subsequent retreatment of the films as a preliminary step in subsequent printing, coating, lamination, converting, or metallizing operations.

Tackifiers

Particularly preferred tackifiers include petroleum/hydrocarbon resins containing or comprising an unsaturated acid or anhydride or derivative thereof (referred to as “resin modifier” when containing the unsaturated acid or anhydride or derivative thereof). Preferably, the resin modifier has molar ratio of tackifier to unsaturated acid or anhydride or derivative thereof ranging from about 50-0.5, more preferably from about 10-2, more preferably from about 5-2, more preferably from about 1.5-0.67, and more preferably about 1. In some embodiments, the weight ratio of unsaturated acid or anhydride or derivative thereof to tackifier is preferably less than 1, in other embodiments ranging from about 0.001-1, more preferably from about 0.01-1, more preferably from about 0.02-1, more preferably from about 0.1-1, and more preferably from about 0.33-1, and in other embodiments between about 0.01 and 0.3, and in other embodiments between about 0.1 and 0.2. The resin modifier generally contains unsaturated acid or anhydride or derivative thereof in an amount about 20 wt % or less, more preferably from about 0.01-20 wt %, more preferably from about 0.01-15 wt %, more preferably from about 0.1-15 wt %, more preferably from about 0.1-10 wt %, more preferably from about 0.5-10 wt %, more preferably from about 0.5-8 wt %, more preferably from about 1-7 wt %, more preferably from about 1-5 wt %, more preferably from about 1.5-5 wt % and more preferably from about 2-5 wt %.

Suitable tackifiers resins that may be modified to contain an unsaturated acid or anhydride or derivative thereof include, but are not limited to: aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and mixtures of two or more thereof. As used herein, rosin includes rosin esters and rosin acids, which may also be hydrogenated.

Suitable commercially available tackifiers that may be modified with an unsaturated acid or anhydride or derivative thereof include Oppera™ PR 100, 101, 102, 103, 104, 105, 106, 111, 112, 115, 120 ECR-373 and Escorez® 1000, 2000 and 5000 series hydrocarbon resins, available from ExxonMobil Chemical Company, ARKON™ M90, M100, M115 and M135 and SUPER ESTER™ rosin esters available from Arakawa Chemical Company of Japan, SYLVARES™ phenol modified styrene-α methyl styrene resins, styrenated terpene resins, ZONATAC terpene-aromatic resins, and terpene phenolic resins available from Arizona Chemical Company, SYLVACOTE™, SYLVATAC™ and SYLVALITE™ rosin esters available from Arizona Chemical Company, NORSOLENE™ aliphatic aromatic resins available from Cray Valley of France, DERTOPHENE™ terpene phenolic resins available from DRT Chemical Company of Landes, France, EASTOTAC™ resins, PICCOTAC™ C₅/C₉ resins, REGALITE™ and REGALREZ™ aromatic and REGALITE™ cycloaliphatic/aromatic resins available from Eastman Chemical Company of Kingsport, Tenn., WINGTACK™ ET and EXTRA available from Goodyear Chemical Company, FORAL™, PENTALYN™, AND PERMALYN™ rosins and rosin esters available from Hercules (now Eastman Chemical Company), QUINTONE™ acid modified C₅ resins, C₅/C₉ resins, and acid modified C₅/C₉ resins available from Nippon Zeon of Japan, and LX™ mixed aromatic/cycloaliphatic resins available from Neville Chemical Company, CLEARON hydrogenated terpene aromatic resins available from Yasuhara. One suitable example of a suitable material is EMFR 100, which is a tackifier containing 2.5 wt % maleic anhydride, made by ExxonMobil Chemical Company. The preceding examples are illustrative only and by no means limiting.

The tackifiers can be modified/reacted in any conventional manner with the unsaturated acid or anhydride or derivative thereof. Particularly preferred methods of hydrocarbon resin production and modification of hydrocarbon resins with an unsaturated acid or anhydride or derivative thereof are described in WO 03/025084, WO 03/025036, WO 03/025037, WO 03/025038, U.S. Pat. Nos. 4,513,130, 6,372,851, 4,719,260, 4,086,198, and 3161620 and EP 0 088 510, all of which are incorporated by reference. The resin modifier preferably comprises one or more reaction products of a tackifier and an unsaturated acid or anhydride or derivative thereof.

In one embodiment, the resin modifier comprises a hydrocarbon resin produced by the thermal polymerization of dicyclopentadiene (DCPD) or substituted DCPD, which may further include aliphatic or aromatic monomers. In one embodiment hydrocarbon resins produced by the thermal polymerization of dicyclopentadiene (DCPD) or substituted DCPD and C₉ monomers contain about 10% or less aromatics in the final resin product. Preferred modifiers for use are EMFR 100 available from ExxonMobil Chemical Company.

The resin modifiers preferably have a molecular weight (Mw) of ≦about 10000, more preferably ≦about 5000, more preferably ≦about 2500, more preferably ≦about 2000. As used herein, molecular weights (number-average molecular weight (Mn), weight-average molecular weight (Mw), and z-average molecular weight (Mz)) are measured by Size Exclusion Chromatography using a Waters 150 Gel Permeation Chromatograph equipped with a differential refractive index detector and calibrated using polystyrene standards. Samples are run in tetrahydrofuran (THF) (45° C.). Molecular weights are reported as polystyrene-equivalent molecular weights and are generally measured in g/mol.

In a preferred embodiment, the tackifier has an aromatic content of about 1-15%, more preferably about 1-10%, and more preferably about 5-10%. The tackifier (either before or after modification/reaction with the unsaturated acid or anhydride or derivative thereof) preferably has a softening point of about 10-200° C., more preferably about 60-130° C., more preferably about 80-120° C., and more preferably about 90-110° C. Softening point (° C.) is preferably measured as a ring and ball softening point according to ASTM E-28 (Revision 1996). As used herein aromatic content and olefin content are measured by ¹H-NMR as measured directly from the ¹H NMR spectrum from a spectrometer with a field strength greater than 300 MHz, most preferably 400 MHz (frequency equivalent). Aromatic content is the integration of aromatic protons versus the total number of protons. Olefin proton or olefinic proton content is the integration of olefinic protons versus the total number of protons.

Though not required, the tackifier is preferably hydrogenated before modification/reaction with the unsaturated acid or anhydride or derivative thereof so that it contains ≦about 50% olefinic protons, more preferably ≦about 25% olefinic protons, more preferably ≦about 10% olefinic protons, more preferably ≦about 1% olefinic protons, more preferably ≦about 0.5% olefinic protons, more preferably ≦about 0.1% olefinic protons. With aromatic containing hydrocarbon resins, the degree of hydrogenation may be conducted to minimize and preferably avoid hydrogenation of the aromatic bonds.

Preferably, the unsaturated acid or anhydride or derivative thereof (or even mixtures thereof) include any unsaturated organic compound containing at least one olefinic bond and at least one polar group such as a carbonyl group. Preferably, the organic compound contains an ethylenic unsaturation conjugated with a carbonyl group (—C═O) and preferably contains at least one α, β olefin bond. Examples include carboxylic acids, acid halides or anhydrides, phenols, alcohols (mono-alcohols, diols, and polyols), ethers, ketones, alkyl and aromatic amines (including polyamines), nitriles, imines, isocyanates, nitrogen compounds, halides and combinations and derivatives thereof. Representative acids and acid derivatives include carboxylic acids, anhydrides, acid halides, esters, amides, imides and their salts, both metallic and non-metallic. Examples include maleic, fumaric, acrylic, methacrylic, itaconic, aconitic, citraconic, himic, tetrahydrophthalic, crotonic, α-methyl crotonic, and cinnamic acids. Maleic anhydride is a particularly preferred unsaturated acid or anhydride or derivative thereof. Further examples include, itaconic anhydride, citraconic anhydride, methyl acrylate, methyl methacrylate, ethyl acrylate, ethyl methacrylate, glycidyl acrylate, monoethyl maleate, diethyl maleate, dibutyl maleate, monomethyl fumarate, dimethyl fumarate, monomethyl itaconate, diethyl itaconate, acrylamide, methacrylamide, maleic acid monoamide, maleic acid diamide, maleic acid-N-monoethylamide, maleic acid-N,N-diethylamide, maleic acid-N-monobutylamide, maleic acid-N,N-dibutylamide, fumaric acid monoamide, fumaric acid diamide, fumaric acid-N-monobutylamide, fumaric acid-N,N-dibutylamide, maleimide, N-butylmaleimide, N-phenylmaleimide, sodium acrylate, sodium methacrylate, potassium acrylate and potassium methacrylate. Preferred unsaturated acids or anhydrides or derivatives thereof include acids, anhydrides, alcohols, amides, and imides.

Preferred ranges for Saponification numbers of the resin modifier are about 1-100, more preferably about 3-100, more preferably about 3-80 or about 5-100, more preferably about 5-50 or about 8-60, more preferably about 10-40, more preferably about 10-30, more preferably about 15-30, and more preferably about 20-30.

### EXAMPLES

The following examples illustrate the benefits of the present invention. The following materials were used in the examples:

LD 362 is an ethylene vinyl acetate copolymer containing 4.5 wt % vinyl acetate having a melt index (ASTM D-1238) of 2 and a melting point (ASTM D-3418) of 104° C., available from ExxonMobil Chemical Company.

LD 363 is an ethylene vinyl acetate copolymer containing 4.5 wt % vinyl acetate having a melt index (ASTM D-1238) of 3 and a melting point (ASTM D-3418) of 103° C., available from ExxonMobil Chemical Company.

FL01418 is an ethylene vinyl acetate copolymer containing 14 wt % vinyl acetate having a melt index (ASTM D-1238) of 18 and a melting point (ASTM D-3418) of 82° C., available from ExxonMobil Chemical Company.

EMFR 100 is a hydrogenated cycloaliphatic/aromatic hydrocarbon resin containing 2.5 wt % maleic anhydride available from ExxonMobil Chemical Company.

Escorez® 5600 hydrocarbon resin is a thermally polymerized aromatic/dicyclopentadiene-based hydrocarbon resin available from ExxonMobil Chemical Company.

Masterbatch 1 was a blended, extruded and pelletized composition containing 50 wt % EMFR 100 and 50 wt % LD 363.

### Examples 1-8

50 μm monolayer blown films were produced in an Alpine mono-blown film line. The film components, in the amounts listed in Tables 1 and 2, were dry-blended (for multiple component films) and extruded in the film line to produce a single layer film. The die diameter was 20 cm, the die gap was 1 mm with die-head setting of 200° C. The blown film line was run under the following conditions: blow-up ratio of 2.5, take off rate 23 m/min, and total output of 90 kg/hr. The films were then corona treated on-line at the energy levels indicated in the Tables and then slit and processed into rolls of 30 cm width.

### Examples 9-11

Extrusion coated structures were produced on a pilot coextrusion coating line. A mixture of 90 wt % FL01418 and 10 wt % EMFR 100 was extruded onto a 70 g/m² kraft paper substrate at a 25 g/m² at the line speed indicated in Table 3. The samples were coated in a monoextrusion coating process, at a melt temperature of 243° C., extruded in an 8.89 cm (3.5 inch) extruder, 0.6 mm die gap, 150 mm air gap with mat chill roll finishing. The paper substrate was corona treated at the level indicated in Table 3.

The films/structures of Examples 1-11 were kept in a controlled area at a temperature of 23° C. at atmospheric pressure and a relative humidity of 50%. The surface tension was then measured at the times indicated in the table as a function of time since the film was first corona treated. Day 0 is the day the films were treated. Surface tension was measured according to ASTM-D-2578/94.

TABLE 1

| | Example | | |
|---|---|---|---|
| | 1 | 2 | 3 |
| | Film | | |
| | | | 90% LD 362 + |
| | LD 362 | LD 362 | 10 wt % Masterbatch 1 |
| | Treating Level | | |
| | 1.5 kW | 3.0 kW | 1.5 kW |
| Day | Surface tension (dynes/cm) | | |
| 0 | | | |
| 4 | 54 | 54 | — |
| 6 | — | — | >60 |
| 10 | 53-54 | 54 | — |
| 12 | — | — | >60 |
| 13 | 53 | 53-54 | — |
| 15 | — | — | >60 |
| 16 | 53 | 54 | — |
| 18 | — | — | >60 |
| 24 | 53 | 54 | — |
| 26 | — | — | >60 |
| 31 | 52 | 54 | — |
| 33 | — | — | >60 |
| 40 | 53 | 54 | — |
| 42 | — | — | >60 |
| 66 | 53 | 53-54 | — |
| 68 | — | — | >60 |

TABLE 2

| | Example | | | | |
|---|---|---|---|---|---|
| | 4 | 5 | 6 | 7 | 8 |
| | Film Components | | | | |
| | 95 wt % | 95 wt % | 90 wt % | 90 wt % | 90 wt % |
| | LD362 + | LD362 + | LD362 + | LD362 + | LD362 + |
| | 5 wt % | 5 wt % | 10 wt % | 10 wt % | 10 wt % |
| | Escorez ® 5600 | Escorez ® 5600 | Escorez ® 5600 | Escorez ® 5600 | Masterbatch 1 |
| | Treating Level | | | | |
| | 1.5 kW | 3.0 kW | 1.5 kW | 3.0 kW | 1.5 kW |
| Day | Surface tension (dynes/cm) | | | | |
| 0 | | | | | |
| 4 | 54 | 56 | 43 | 46 | — |
| 6 | — | — | — | — | >60 |
| 10 | 53-54 | 55 | 41 | 43 | — |
| 12 | — | — | — | — | >60 |
| 13 | 52 | 53 | 40-41 | 42 | — |
| 15 | — | — | — | — | >60 |
| 16 | 51 | 52 | 40 | 40-41 | — |
| 18 | — | — | — | — | >60 |
| 24 | 51 | 52-53 | 40-41 | 41 | — |
| 26 | — | — | — | — | >60 |
| 31 | 49 | 52 | 39 | 40 | — |
| 33 | — | — | — | — | >60 |
| 40 | 49 | 52 | 39 | 40 | — |
| 42 | — | — | — | — | >60 |
| 66 | 48 | 51-52 | 39-40 | 40 | — |
| 68 | — | — | — | — | >60 |

TABLE 3

| | | Example | | |
|---|---|---|---|---|
| | | 9 | 10 | 11 |
| | | Film Components | | |
| | | | 90 wt % FL01418 + | 90 wt % FL01418 + |
| | | 100 wt % FL01418 | 10 wt % EMFR 100 | 10 wt % EMFR 100 |
| | | Line Speed (m/min) | | |
| | | 100 | 50 | 100 |
| | | Corona Treatment Level (kW) | | |
| | | 1 | 1 | 1 |
| Time Since Treatment | | Surface tension (dynes/cm) | | |
| 0 | | 58-60 | 58-60 | >60 |
| 1 | day | 54-55 | 58-60 | >60 |
| 3 | days | 54 | 56-58 | 60 |
| 6 | days | 52 | 56 | 60 |
| 8 | days | 52 | 55 | 60 |
| 13 | days | 51 | 55 | 58 |
| 16 | days | 47 | 54 | 58 |
| 20 | days | 46 | 54 | 58 |
| 24 | days | 46 | 54 | 57 |
| 31 | days | 45 | 53 | 55 |
| 37 | days | 43 | 52 | 54 |
| 43 | days | 43 | 52 | 54 |
| 49 | days | 43 | 52 | 53 |
| 78 | days | 42 | 52 | 52 |

| | | | |
|---|---|---|---|
| 4 months, 6 days | 42 | 52 | 52 |
| 6 months, 26 days | 42 | 54 | 54 |
| 10 months, 18 days | 42 | 54 | 54 |

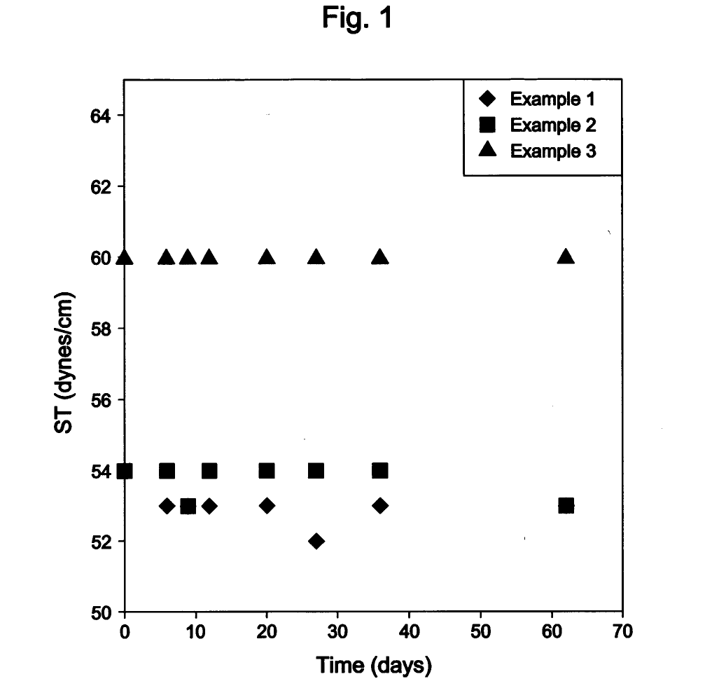

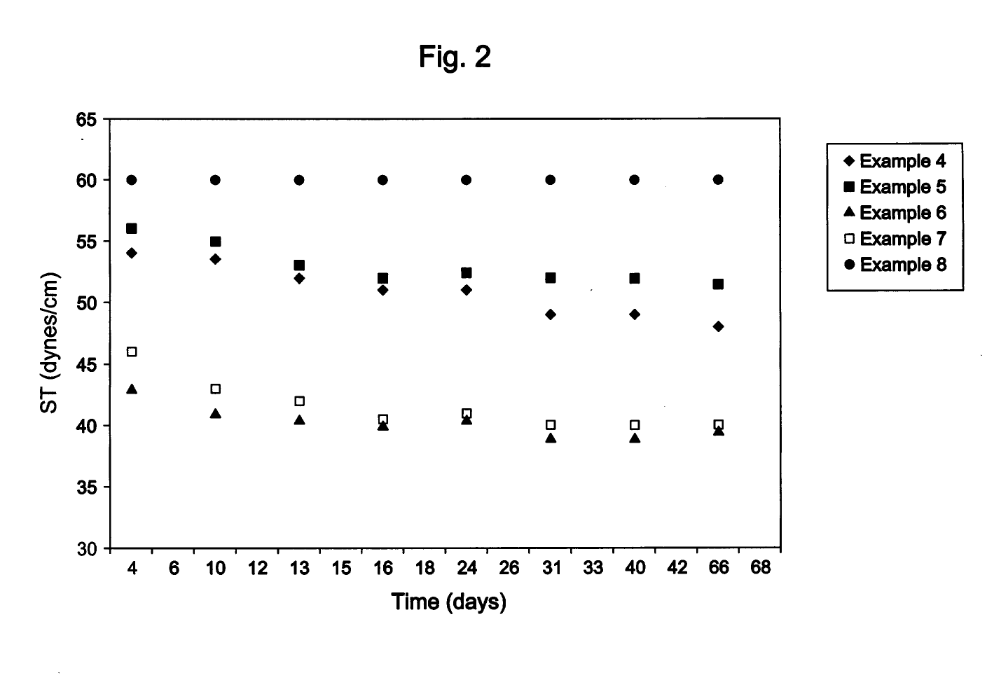

The results from Tables 1 and 2 are illustrated in FIGS. 1 and 2. These results and the results from Table 3 illustrate (i) the increased level of surface tension on the addition of the resin modifier, (ii) the improved level of surface tension even at half the treating power and (iii) the excellent retention of surface tension over time.

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the true scope of the present invention. All documents cited herein, including testing procedures, are herein fully incorporated by reference for all jurisdictions in which such incorporation is permitted.

1-41. (canceled)

41. A surface-treated article comprising at least one layer comprising about 20 wt % or less of a resin modifier comprising a tackifier selected from the group consisting of aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and mixtures of two or more thereof, wherein the tackifier has a molecular weight (Mw) of about 10,000 or less and wherein the resin modifier comprises about 20 wt % or less unsaturated acid or anhydride or derivative thereof.

42. The article according to claim 41 wherein the resin modifier comprises one or more reaction products of the tackifier and unsaturated acid or anhydride or derivative thereof.

43. The article according to claim 41 wherein the layer containing the resin modifier comprises 0.1-5 wt % resin modifier based on the weight of the layer.

44. The article according to claim 43 wherein the layer containing the resin modifier comprises 0.1-10 wt % resin modifier based on the weight of the layer.

45. The article according to claim 41 wherein the resin modifier comprises 0.1-15 wt % unsaturated acid or anhydride or derivative thereof.

46. The article according to claim 45 wherein the resin modifier comprises 0.1-10 wt % unsaturated acid or anhydride or derivative thereof.

47. The article according to claim 46 wherein the resin modifier comprises 1-5 wt % unsaturated acid or anhydride or derivative thereof.

48. The article according to claim 44 wherein the resin modifier comprises 1-5 wt % unsaturated acid or anhydride or derivative thereof.

49. The article according to claim 41 wherein the tackifier is a cycloaliphatic aromatic hydrocarbon resin comprising about 15% or less aromatics.

50. The article according to claim 41 wherein the unsaturated acid or anhydride or derivative thereof is maleic anhydride.

51. The article according to claim 41 wherein the layer containing the resin modifier is flame treated or corona treated.

52. The article according to claim 48 wherein the layer containing the resin modifier is flame treated or corona treated.

53. The article according to claim 41 further comprising a layer comprising paper, wood, cardboard, fabric, non-woven material, polyvinyl chloride, plastic, polyamide, or metal.

54. The article according to claim 52 further comprising a layer comprising paper, wood, cardboard, fabric, non-woven material, polyvinyl chloride, plastic, polyamide, or metal.

55. The article according to claim 41 further comprising a coating layer, a printed layer, a barrier layer, an adhesive layer or a metal layer.

56. The article according to claim 48 further comprising a coating layer, a printed layer, a barrier layer, an adhesive layer or a metal layer.

57. The article according to claim 52 further comprising a coating layer, a printed layer, a barrier layer, an adhesive layer or a metal layer.

58. A mono- or multilayer film comprising at least one layer comprising about 20 wt % or less of a resin modifier comprising a tackifier selected from the group consisting of aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and mixtures of two or more thereof, wherein the tackifier has a molecular weight (Mw) of about 10,000 or less and wherein the resin modifier comprises about 20 wt % or less unsaturated acid or anhydride or derivative thereof.

59. The film according to claim 58 wherein the article is a film comprising a core layer and at least one outer layer.

60. The film according to claims 58 wherein the film is mono- or biaxially oriented.

61. The film according to claim 58 wherein the resin modifier comprises one or more reaction products of the tackifier and unsaturated acid or anhydride or derivative thereof.

62. The film according to claim 58 wherein the layer containing the resin modifier comprises 0.1-5 wt % resin modifier based on the weight of the layer.

63. The film according to claim 62 wherein the layer containing the resin modifier comprises 0.1-10 wt % resin modifier based on the weight of the layer.

64. The film according to claim 58 wherein the resin modifier comprises 0.1-15 wt % unsaturated acid or anhydride or derivative thereof.

65. The film according to claim 64 wherein the resin modifier comprises 1-5 wt % unsaturated acid or anhydride or derivative thereof.

66. The film according to claim 58 wherein the unsaturated acid or anhydride or derivative thereof is maleic anhydride.

67. The film according to claim 58 wherein the layer containing the resin modifier is flame treated or corona treated.

68. The film according to claim 58 further comprising a coating layer, a printed layer, a barrier layer, an adhesive layer or a metal layer.

69. The film according to claim 68 further comprising a coating layer, a printed layer, a barrier layer, an adhesive layer or a metal layer.

70. The film according to claim 59 wherein the core layer is selected from polyamide, ethylene vinyl alcohol copolymers, a homopolymer, copolymer and/or a terpolymer of one or more C₂ to C₄₀ olefins and/or combinations thereof.

71. The film according to claim 59 wherein the at least one outer layer comprises a homopolymer, copolymer and/or a terpolymer of one or more C₂ to C₄₀ olefins.

72. The film according to claim 71 wherein the polymer is selected from ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, mPEs, mPPs, ethylene acrylic acid copolymer, ethylene vinyl acetate, ionomers, ethylene propylene rubber, ethylene propylene diene monomer rubber, neoprene, and combinations of any two or more thereof.

73. The film according to claim 59 further comprising in one layer thereof, a tackifier selected from the group consisting of aliphatic hydrocarbon resins, hydrogenated aliphatic hydrocarbon resins, aliphatic/aromatic hydrocarbon resins, hydrogenated aliphatic aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and mixtures of two or more thereof.

74. The film according to claim 72 wherein the film comprises an ethylene vinyl acetate copolymer containing about 20 wt % or less vinyl acetate.

75. The film according to claim 74 wherein the film comprises an ethylene vinyl acetate copolymer containing less than 5 wt % vinyl acetate.

76. The film according to claim 58 wherein the film has initial surface tension after surface treatment and wherein the treated surface retains at least 90% of its initial surface tension after 30 days.

77. The film according to claim 76 wherein the film retains at least 90% of its initial surface tension after 60 days.

78. A process comprising:
(a) preparing an article having one or more layers, at least one of the layers comprising a polymer and about 20 wt % or less of a resin modifier based on the weight of the layer, the resin modifier having a molecular weight (Mw) of about 10,000 or less and comprising about 20 wt % or less unsaturated acid or anhydride or derivative thereof; and,
(b) surface treating the layer comprising the resin modifier.

79. A process according to claim 78 wherein the surface treatment is corona or flame treatment.

80. A process according to claim 78 wherein the article is a film having at least one layer.

81. A process according to claim 79 wherein the article is a film having at least one layer.

82. A process according to claim 81 wherein the film is multilayer and the resin modifier is present in an outer layer.

83. A process according to claim 81 wherein the film has at least three layers and the resin modifier is present in an inner layer and optionally in an outer layer.

84. A process according to claim 81 wherein the resin modifier comprises one or more reaction products of the tackifier and unsaturated acid or anhydride or derivative thereof.

85. A process according to claim 81 wherein the unsaturated acid or anhydride or derivative thereof is maleic anhydride.

86. A process according to claim 81 wherein the article comprising the resin modifier is prepared from a masterbatch comprising the resin modifier and a polyolefin and optionally an additional polyolefin.

87. A process according to claim 81 further comprising printing, painting, laminating, coating, or metallizing the surface treated layer.

88. A process comprising packaging an article of manufacture with the film produced by the process according to claim 81.

89. A process comprising packaging an article of manufacture with the film produced by the process according to claim 87.

90. A laminate comprising a film according to claim 58.

91. A laminate comprising the product of a process according to claim 81.

92. A packaging film, packaged article, tape, label, coextruded or extrusion-coated substrate comprising a film according to claim 58.

93. A container comprising a label according to claim 92.
